(19) United States
(12) Patent Application Publication
(10) Pub. No.: US 2014/0069284 A1
(43) Pub. Date: Mar. 13, 2014

(54) CHAFER FRAME WITH FOLDABLE LEGS

(71) Applicants: Junjie Zhou, Zhejiang (CN); Chunyao Wang, Zhejiang (CN); Zhengyu Li, Zhejiang (CN)

(72) Inventors: Junjie Zhou, Zhejiang (CN); Chunyao Wang, Zhejiang (CN); Zhengyu Li, Zhejiang (CN)

(73) Assignee: YINDU KITCHEN EQUIPMENT CO., LTD., Zhejiang (CN)

(21) Appl. No.: 14/113,479

(22) PCT Filed: Aug. 1, 2011
(86) PCT No.: PCT/CN2011/077842

§ 371 Date: Oct. 23, 2013

(30) Foreign Application Priority Data
May 6, 2011 (CN) 201110115833.9

(51) Int. Cl. A47J 39/02

(52) U.S. Cl. CPC A47J 39/02
USPC 99/483

(57) ABSTRACT

A chafer frame with foldable legs, comprising a frame and an alcohol burner support, wherein the alcohol burner support is arranged below the frame; the chafer frame also comprising two strip-shaped legs which are curved into U-shape, both ends of the strip-shaped legs are rotatably connected to the frame respectively, and the bottom of the strip-shaped legs are detachably connected to the alcohol furnace support; when folding the chafer frame, the strip-shaped legs are disassemblied from the alcohol furnace support and then rotated inwardly, in this way, the strip-shaped legs can be folded inside the frame. The centre of the frame is defined as inward, and the edge of the frame as outward.

### FIELD OF THE INVENTION

The invention relates to a chafer frame.

### BACKGROUND OF THE INVENTION

A chafer frame used on the market currently, by reference to FIG. 1 and FIG. 2, have four separate feet, each of which is connected to the frame by a rivet; two feet on the left side and two feet right side are respectively connected to each other by connecting strips. An alcohol burner support is supported by and connected to the two feet on the left and the two feet on the right sides via connecting strips. For folding the chafer frame, the two feet on the left and right sides are respectively folded inward so as to achieve the aim of reducing packaging volume of the chafer and lowering cost of packaging, storage and transportation. However, as two feet connected to the connecting strips are perpendicular to the connecting strips, the chafer, after being folded, still takes up a certain space in height; in addition, the feet are complex for manufacturing, too heavy and high cost.

### SUMMARY OF THE INVENTION

The invention aims to overcome shortcomings of the existing chafer frame in terms of larger space occupation after being folded, cumbersome for manufacturing, too heavy and high cost, and provides a chafer frame with foldable legs characterized in reduced space occupation after being folded, simplified manufacturing process, reduced weight and lower cost.

In order to solve the technical problems, the invention adopts such a technical scheme as below:

A chafer frame with foldable legs, comprising a frame and an alcohol burner support, wherein the alcohol burner support is arranged below the frame; the chafer frame also comprising two strip-shaped legs which are curved into U-shape, both ends of the strip-shaped legs are rotatably connected to the frame respectively, and the bottom of the strip-shaped legs are detachably connected to the alcohol furnace support; when folding the chafer frame, the strip-shaped legs are disassemblied from the alcohol furnace support and then rotated inwardly, in this way, the strip-shaped legs can be folded inside the frame. The centre of the frame is defined as inward, and the edge of the frame as outward.

Further, the distance between the two ends of the strip-shaped leg is bigger than or equal to double height of the strip-shaped leg so that both strip-shaped legs can be folded inwardly.

Further, a first rivet hole is arranged at the each end of the strip-shaped legs, a second rivet hole is respectively arranged at the left side and right side of the frame, and a rivet passes through the second rivet hole and the first rivet hole. As a frequently-used connection mode, riveting is convenient for operation. Of course, other rotatable connection modes (for example, pin connection) can also be adopted.

On the frame a link stopper is arranged;

Preferably, the link stopper installed on the frame lies inwardly near the joint where the strip-shaped leg is connected to the frame, there is a bending part on the top of the link stopper to position the strip-shaped legs, when the frame is folded, the bottom of the bending part constituions the limit for the rotation of the strip-shaped leg, and when the frame is opened, the outward side of the bending part constituions the limit for the rotation of the strip-shaped leg. The link stopper is arranged so as to fold the frame reliably. Although the frame can also be folded without such a link stopper, the operation for folding the frame is cumbersome because folding angles need locating and aligning. A 90-degree bending angle for the bending part between remains of the link stopper is preferably selected although other degrees are also permissible.

The end of the strip-shaped legs is located inside the frame, and the link stopper is located inside or outside the frame.

The outside of the frame is provided with a hook for hooking a chafe cover, the hook is arranged at the inward side of the joint where the strip-shaped leg is connected to the frame, the hook is provided with a bending section for positioning the strip-shaped legs; a 90-degree angle is preferably selected for the bending section between the remains of the hook, although other degrees are also permissible. The bending section enter inside the frame, when the frame is folded, the bottom of the bending section constituions the limit for the rotation of the strip-shaped leg, and when the frame is opened, the outward side of the bending section constituions the limit for the rotation of the strip-shaped leg.

The alcohol burner support is provided with a lancing tongue, and bottom of the strip-shaped legs is connected to the lancing tongue propping up the strip-shaped legs, convenient for disassembling. Of course, other detachable connection modes can also be adopted.

The invention has such main advantages as below: 1. Compared with the prior art, the alcohol burner support is directly connected to bottom of the U-shaped strip-shaped legs with no aid of connecting strips, thus the chafer frame after being folded occupies less space in height; 2. Compared with four-leg structure, the strip-shaped leg structure consumes fewer materials and is simple for manufacturing; 3. Cost of manufacturing, packaging, storage and transportation is lowered.

### BRIEF DESCRIPTION OF THE DRAWINGS

FIG. 1 is a structural drawing of the prior art.

FIG. 2 is a diagrammatic drawing of the prior art after being folded.

FIG. 3 is an external view of the chafer frame with foldable legs of the invention.

FIG. 4 is a view of the chafer frame after being folded of the invention

FIG. 5 is a view of the alcohol burner support of the invention.

FIG. 6 is a view of the hook of the invention.

FIG. 7 is a view of the link stopper of the invention.

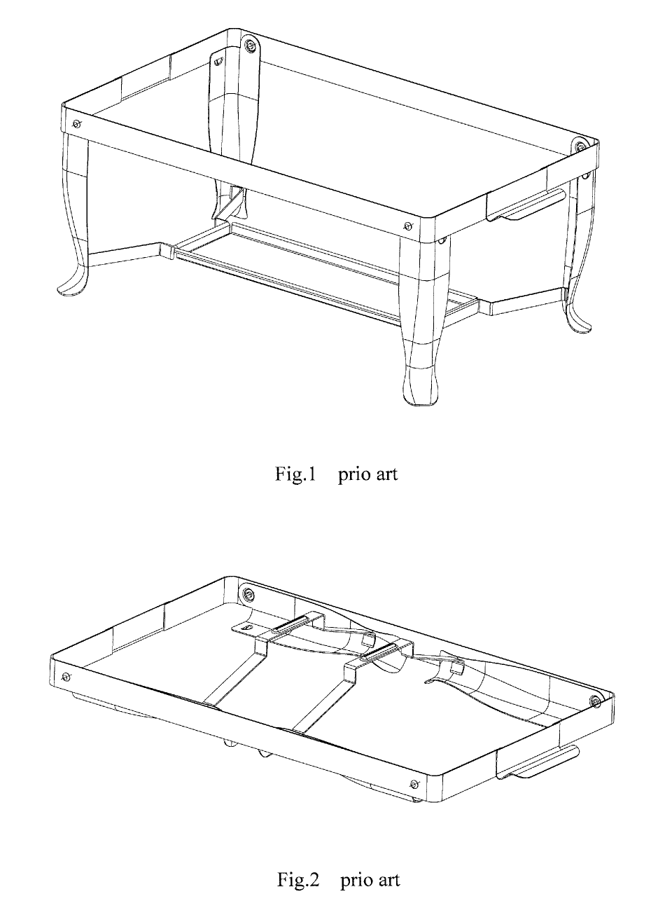

### DETAILED DESCRIPTION OF THE EMBODIMENTS

Further description of the invention is made in conjunction with the drawings.

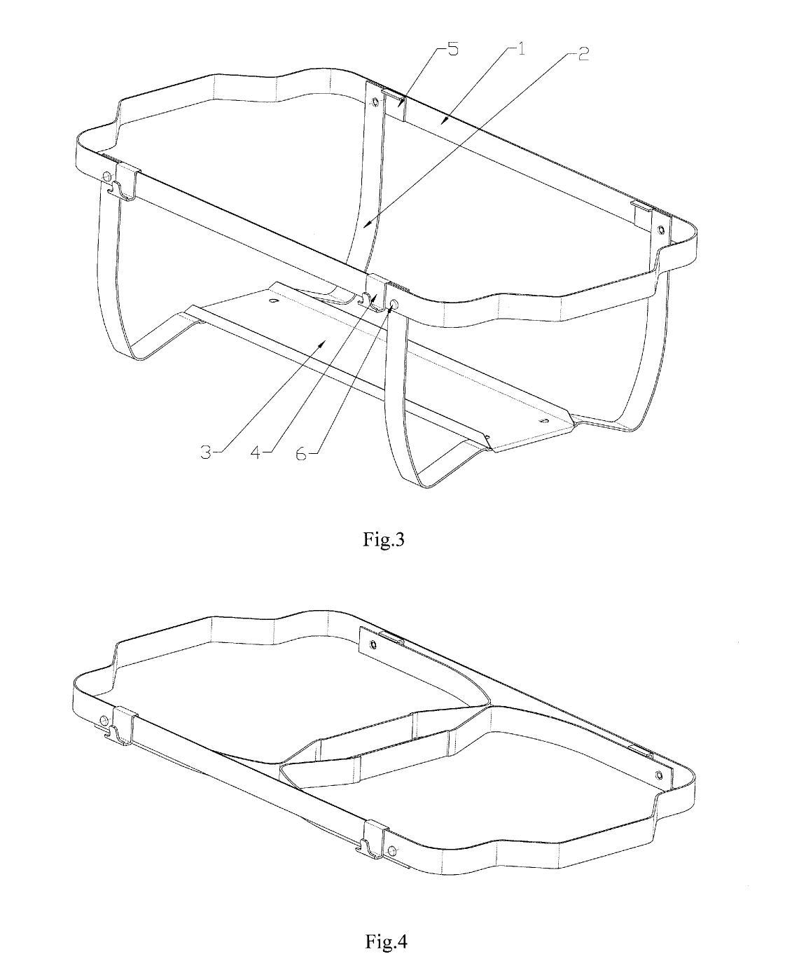

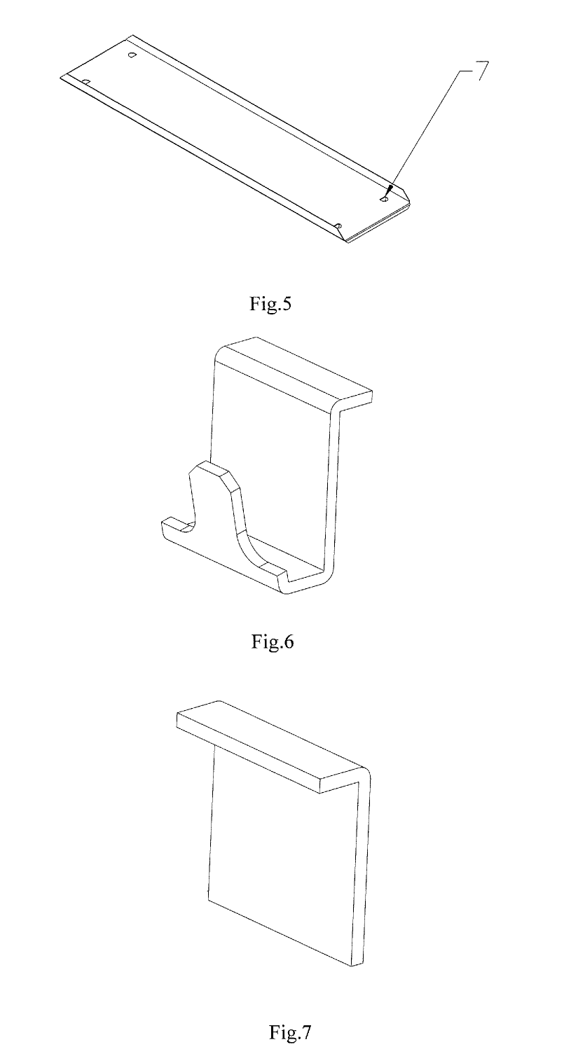

By reference to FIGS. 3-7, a chafer frame with foldable legs, comprising a frame 1 and an alcohol burner support 3, wherein the alcohol burner support 3 is arranged below the frame 1; the chafer frame also comprising two strip-shaped legs 2 which are curved into U-shape, both ends of the strip-shaped legs 2 are rotatably connected to the frame 1 respectively, and the bottom of the strip-shaped legs 2 are detachably connected to the alcohol furnace support 3. When folding the chafer frame, the strip-shaped legs 2 are disassemblied from the alcohol furnace support 3 and then rotated inwardly, in this way, the strip-shaped legs 2 can be folded inside the frame 1. The centre of the frame is defined as inward, and the edge of the frame as outward.

The distance between the two ends of the strip-shaped leg 2 is bigger than or equal to double height of the strip-shaped leg so that both strip-shaped legs can be folded inwardly.

A first rivet hole is arranged at each end of the strip-shaped legs 2, a second rivet hole is respectively arranged at the left side and right side of the frame 1, and a rivet 6 passes through the second rivet hole and the first rivet hole. As a frequently-used connection mode, riveting is convenient for operation. Of course, other rotatable connection modes (for example, pin connection) can also be adopted.

Preferably, the link stopper 5 installed on the frame 1 lies inwardly near the joint where the strip-shaped leg 2 is connected to the frame 1, there is a bending part on the top of the link stopper 5 to position the strip-shaped legs 2. when the frame 1 is folded, the bottom of the bending part constituions the limit for the rotation of the strip-shaped leg 2, and when the frame 1 is opened, the outward side of the bending part constituions the limit for the rotation of the strip-shaped leg 2. The link stopper 5 is arranged so as to fold the frame 1 reliably. Although the frame 1 can also be folded without such a link stopper 5, the operation for folding the frame 1 is cumbersome because folding angles need locating and aligning. A 90-degree bending angle for the bending part between remains of the link stopper 5 is preferably selected although other degrees are also permissible. The top of the strip-shaped legs 2 is located inside the frame 1, and the link stopper 5 is located inside or outside the frame 1.

For another embodiment, the outside of the frame 1 is provided with a hook 4 for hooking a chafe cover, the hook 4 is arranged at the inward side of the joint where the strip-shaped leg 2 is connected to the frame 1, the hook 4 is provided with a bending section for positioning the strip-shaped legs 2; a 90-degree angle is preferably selected for the bending section between the remains of the hook 4, although other degrees are also permissible. The bending section enter inside the frame 1, when the frame 1 is folded, the bottom of the bending section constituions the limit for the rotation of the strip-shaped leg 2, and when the frame 1 is opened, the outward side of the bending section constituions the limit for the rotation of the strip-shaped leg 2.

The alcohol burner support 3 is provided with lancing tongues 7, and bottom of the strip-shaped legs 2 is connected to the lancing tongues 7; bottom of the strip-shaped legs 2 is usually connected to two lancing tongue supports. The lancing tongues 7 prop up the bottom of the strip-shaped legs 2, convenient for disassembling. Of course, other detachable connection modes can also be adopted.

In the embodiment, FIG. 2 shows the working condition of the chafer. A rivet hole is respectively arranged near four corners of the frame 1, two rivet holes are respectively arranged on the ends of both the strip-shaped legs 2, the strip-shaped legs 2 are riveted on the frame 1 by a rivet 6 respectively, the strip-shaped legs 2 are rotatable around the rivet on the frame 1, the top of the strip-shaped legs 2 is blocked by the 90-degree bending angles of the hook 4 or the link stopper 5, so as to prevent the strip-shaped legs 2 from rotating outwardly. Bottom of the strip-shaped legs 2 is fixed by the lancing tongues 7 at both sides of the alcohol burner support 3 so as to prevent the strip-shaped legs 2 from rotating inwardly. For folding the chafer frame, the alcohol burner support 3 is dismantled, both the left and right strip-shaped legs 2 are rotated inwardly until the chafer frame is folded like the shape shown in FIG. 3.

Compared with an existing product, the alcohol burner support in the embodiment has the advantages of consuming fewer materials, being simple for manufacturing and occupying less space after being folded.

What is mentioned in the embodiment of the specification is merely for illustration of the inventive concept. The scope of protection of the invention shall be not deemed as what is concretely stated in the embodiment. Any equivalent technical means conceived by those skilled in the art on the basis of the inventive concept are also within the scope of protection of the invention.

1. A chafer frame with foldable legs, comprising a frame and an alcohol burner support, wherein the alcohol burner support is arranged below the frame; the chafer frame also comprising two strip-shaped legs which are curved into a U-shape, both ends of the strip-shaped legs are rotatably connected to the frame respectively, and the bottom of the strip-shaped legs are detachably connected to the alcohol furnace support; and wherein the outside of the frame is provided with a hook for hooking a chafe cover, the hook is arranged at the inward side of a joint where the strip-shaped leg is connected to the frame, the hook is provided with a bending section for positioning the strip-shaped legs; the bending section enters inside the frame, when the frame is folded, the bottom of the bending section constitutes the limit for rotation of the strip-shaped leg, and when the frame is opened, the outward side of the bending section constitutes the limit for the rotation of the strip-shaped leg.

2. The chafer frame with foldable legs according to claim 1, wherein the distance between the two ends of the strip-shaped leg is greater than or equal to double height of the strip-shaped leg so that both strip-shaped legs can be folded inwardly.

3. The chafer frame with foldable legs according to claim 1, wherein a first rivet hole is arranged at each end of the strip-shaped legs, a second rivet hole is respectively arranged at the left side and right side of the frame, and a rivet passes through the second rivet hole and the first rivet hole.

4. A The chafer frame with foldable legs according to claim 1, wherein a link stopper is arranged on the frame.

5. The chafer frame with foldable legs according to claim 4, wherein the link stopper on the frame lies inwardly near the joint where the strip-shaped leg is connected to the frame, there is a bending part on the top of the link stopper to position the strip-shaped legs ; when the frame is folded, the bottom of the bending part constitutes the limit for the rotation of the strip-shaped leg, and when the frame is opened, the outward side of the bending part constitutes the limit for the rotation of the strip-shaped leg.

6. A The chafer frame with foldable legs according to claim 4, wherein the end of the strip-shaped legs is located inside the frame, and the link stopper is located inside or outside the frame.

7. (canceled)

8. A The chafer frame with foldable legs according to claim 1, wherein the alcohol burner support is provided with a lancing tongue, and bottom of the strip-shaped legs is connected to the lancing tongue propping up the strip-shaped legs.
